(19) United States
(12) Patent Application Publication
(10) Pub. No.: US 2018/0122216 A1
(43) Pub. Date: May 3, 2018

(54) Method, Device and System for Transmitting and Differentiating Constitutional States when Triggering an Alarm

(71) Applicant: Rudolf King, Altenstadt (DE)

(72) Inventor: Rudolf King, Altenstadt (DE)

(21) Appl. No.: 15/572,781

(22) PCT Filed: May 17, 2016
(86) PCT No.: PCT/EP2016/061018

§ 371 Date: Nov. 8, 2017

(30) Foreign Application Priority Data
Jun. 5, 2015 (DE) 202015003905.7

(51) Int. Cl. G08B 25/00; G08B 21/04

(52) U.S. Cl. CPC G08B 25/006; G08B 25/005; G08B 21/0453

(57) ABSTRACT

A system for transmitting and differentiating constitutional states during and after triggering a personal emergency system (personal emergency response system—PERS) or a social emergency network (social emergency network—SEN) is described, in which a differentiation initially takes place as to what kind of emergency felt more or less strongly is present, and consequently a differentiating emergency alarm is transmitted, in which another group of first responders (first responders) can be addressed, the constitutional state, intensity and urgency are transmitted, and more, additional or other technical consequences can be triggered.

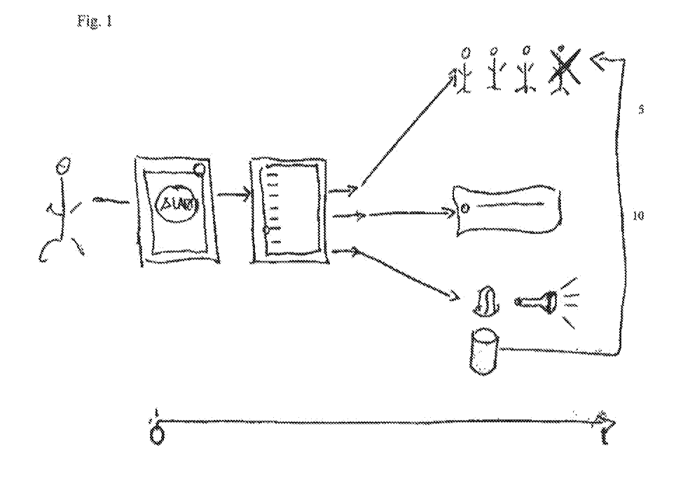

The present invention relates to a method, a device and a system for transmitting and differentiating constitutional states when triggering an alarm. Provided in particular is a system for transmitting and differentiating constitutional states during and after triggering a personal emergency system (personal emergency response system—PERS) or systems for notifying a social emergency network (social emergency network—SEN).

This invention is a follow-up application from the same inventor of the following inventions:
EP 1 679 672 A1, “Portable pulse monitoring device and method of its operation”,
PCT/EP 2014 055495, WO 2014/170081 A1, “System and method to facilitate assistance in distress situations”,
PCT/EP 2015/060331, “Personal emergency response system & method of operation:
   a) Energy conversation in bracelets and pendants;
   b) bread crumb/beeline GPS positioning;
   c) mobile internet-based SEN functionality”,
      and must be viewed in conjunction with the latter. Reference is made to the operating modes described therein, in particular for the portable electronic devices, energy saving modes and applications for the latter. It is further used in other applications, primarily and preferably for triggering alarms.

### DESCRIPTION OF PRIOR ART

### Starting Position

In the last 20 years, personal emergency systems have made their way into the lives in particular of
older people,
people in need of assistance,
children, and also
people in occupations that can be exposed to dangerous situations specific to location and/or occupation.

Common to all systems is that, once the emergency alarm has been triggered, a call is made to one or more third persons, whether it be an emergency call center, i.e., usually a call center, or one or more people from the family and/or acquaintances of the user.

Conspicuously, the alarm is transmitted undifferentiated in all emergency systems currently on the market. The reason for this is that the emergency systems industry was initially dependent on landline networks, in which queries could only be made through the call center or friends; the latter could or at least should find out the reason by inquiring.

### Problem Definition

As a negative consequence of the above, emergency systems on the market are disliked among other things because the lack of differentiation puts the recipient of the emergency signal in a situation that basically requires maximum attention and immediate action, even if such a case is not present; for example, an elderly person might have come to an agreement with a family member that the family member will care for the elderly person, not just in an emergency, but also cook for the latter, for example. If the elderly family member now feels extremely hungry, he or she will press the emergency alarm, for example having forgotten the telephone number of the younger family member, and thereby trigger the same emotional condition in the younger family member that an accident would. Only an inquiry will diffuse, calm and clarify the situation. Conversely, years of routine use of the alarm call to order food with the family member might well bring about a mental state reflecting the motto “He/she is hungry again” and cause a delayed reaction that might possibly not be adequate for a sudden, real and serious emergency.

### Specification

The present invention is provided by the attached claims. In particular, the present invention provides a method for differentiating constitutional states when triggering an emergency alarm on a portable electronic device, which consists of displaying a plurality of alarm states, determining a first user selection, wherein the first selection determines a type of alarm state; displaying an urgency and/or intensity scale; determining a second user selection, wherein the second selection corresponds to an urgency and/or intensity of the alarm state first selected; and transmitting an alarm signal to a predetermined group of alarm recipients, wherein the predetermined group of alarm recipients is determined based on the first selection and second selection.

The term “emergency alarm” or “alarm” must be broadly interpreted in conjunction with the present invention. An emergency can involve a medical incident requiring immediate measures (heart attack), an accident (serious fall to sprained ankle), as well as less serious events that in everyday language do not represent/require an emergency or alarm, e.g., hunger, boredom, freezing, etc.

In an embodiment of the present invention, the urgency and/or intensity scale can be displayed in the form of a diagram, wherein one axis represents the urgency, and the other axis the intensity of the incident. The user of an electronic device with touch-sensitive display (“touch screen”) can thus adjust data relating to urgency and intensity with a single motion, e.g., by touching a point on the diagram or pulling the marker to the desired point of the diagram.

In an embodiment of the invention, the detection result of a sensor of the electronic device limits the display of a plurality of alarm states. For example, the selection can automatically be limited to a number of falls or accidents varying in severity by having a tilt or acceleration sensor detect an unusual tilting motion or impact. In an embodiment, the alarm states are limited by resorting a displayed list; however, unlikely emergencies continue to be displayed, albeit further down on the list.

In an embodiment of the invention, each possible alarm state corresponds to an adjustable group of alarm recipients, wherein the second user selection expands the adjustable group of alarm recipients as a function of the selected urgency and/or intensity if the urgency and/or intensity exceeds a predetermined threshold of the alarm state.

In conjunction with a patent of the patent applicant (WIPO WO 2014/170081, DE 812752671), the above urgency along with modifications in both urgency and intensity can be used to determine that other groups of people or narrower groups of people and first responders be contacted.

In an embodiment of the invention, the method is implemented on an electronic device, which is integrated into a personal emergency system, PERS, or a social emergency network, SEN.

In an embodiment of the invention, the method further involves displaying a scale corresponding to a privacy setting, determining a privacy user selection, and limiting the group of alarm recipients determined through the first and second user selection based on the privacy selected by the user.

An embodiment of the present invention provides an electronic device for differentiating between constitutional states when triggering an emergency alarm, consisting of a display device; and a calculation unit adjusted to display a plurality of alarm states on the display device; determine a first user selection, wherein the first selection determines a type of alarm state; display an urgency and/or intensity scale on the display device; determine a second user selection, wherein the second selection corresponds to an urgency and/or intensity of the alarm state of the first selection; and transmit an alarm signal to a predetermined group of alarm recipients, wherein the predetermined group of alarm recipients is determined based on the first selection and second selection.

In an embodiment of the invention, the electronic device further has a sensor, wherein a detection result of the sensor limits the display of the plurality of alarm states.

In an embodiment of the invention, each possible alarm state corresponds to an adjustable group of alarm recipients, wherein the first user selection expands the adjustable group of alarm recipients as a function of the selected urgency and/or intensity if the urgency and/or intensity exceeds a predetermined threshold of the alarm state.

In conjunction with a patent of the patent applicant (WIPO WO 2014/170081, DE 812752671), the above urgency along with modifications in both urgency and intensity can be used to determine that other groups of people or narrower groups of people and first responders be contacted.

In an embodiment of the invention, the electronic device is integrated into a personal emergency system, PERS, or a social emergency network, SEN.

In an embodiment of the invention, the calculation unit is further adjusted to display a scale corresponding to a privacy setting on the display device; determine a privacy selection of the user, and limit the group of alarm recipients determined by the first and second user selection based on the privacy selected by the user.

An embodiment of the invention provides a system for differentiating between constitutional states after triggering an emergency alarm, comprised of a display of preset constitutional states that can be selected after triggering an emergency alarm; wherein the system is adjusted to inform preset first responders determined based on a selection.

In an embodiment of the invention, the user selection can trigger other, preset external technical consequences.

In an embodiment, the selection of the constitutional state is synchronized with the triggering of the emergency signal.

In an embodiment of the invention, other correspondingly predefined constitutional states are displayed and fixed at determined speeds, and based on the selection made relayed to other groups of people with an adjusted notification.

In an embodiment of the invention, other correspondingly predefined constitutional states are displayed and fixed at determined, predefined locations, and correspondingly relayed to other groups of people with an adjusted notification.

An embodiment of the invention provides a computer program product, which is adjusted so as to implement a method according to the above specification when executed by an electronic device.

An embodiment of the invention provides a computer-readable storage medium comprised of a program code that implements a method according to the above specification when executed by an electronic device.

### Optional Embodiments

An optional embodiment provides a system for differentiating between constitutional states after triggering an emergency alarm comprised of a display of preset constitutional states that can be selected after triggering an emergency alarm; wherein the system is adjusted to inform a preset first responder determined based on a selection.

In an optional embodiment, the constitutional state and preset intensity and urgency corresponding thereto are transmitted according to the selection.

In an optional embodiment, the user can modify the intensity and/or urgency.

In an optional embodiment, the user selection can trigger other, preset external technical consequences.

In an optional embodiment, the selection of the constitutional state coincides in terms of time with the triggering of the emergency signal.

In an optional embodiment, information is transmitted without urgency.

In an optional embodiment, the preset group of people is modified during and by the selection.

In an optional embodiment, other correspondingly predefined constitutional states are displayed and fixed at determined speeds, and based on the selection made relayed to other groups of people with an adjusted notification.

In an optional embodiment, other correspondingly predefined constitutional states are displayed and fixed at determined, predefined locations, and correspondingly relayed to other groups of people with an adjusted notification.

In an optional embodiment, other technical consequences and events are triggered.

In an optional embodiment, the sensors that trigger the emergency signal simultaneously select the constitutional state corresponding to the determined triggering cause.

In an optional embodiment, the first responders are not differentiated.

In an optional embodiment, other stored information is transmitted by the device used to trigger the alarm.

In an optional embodiment, other stored information is transmitted by a device on which the information is stored.

In an optional embodiment, the information to be transmitted is calculated by an algorithm, which uses the transmitted differentiation and/or other transmitted values.

### Explanation of the Invention

A system in which a differentiation initially takes place through user selection as to what kind of emergency felt more or less strongly is present, and, as a consequence of this selection, another step involves [transmitting] an emergency alarm that differentiates to this extent, in which another group of first responders (first responders) can be addressed on the one hand; on the other hand, in conjunction with Patent WIPO WO 2014/170081 (DE 812752671) of the signatory patent applicant, or more precisely with the life circles described therein, a differentiation can further take place to the extent that other technical consequences can be triggered after combining the determined location and differentiated indication of the emergency.

### Description of the Method

It will first be explained below how a differentiation by alarm can take place after the alarm has been triggered; part two will describe how alarm triggering and differentiation can take place at the same time.

1. Alarm and Subsequent Differentiation

In emergency systems currently available on the market, when a user presses an emergency button, a countdown is routinely triggered, giving the triggering user the opportunity, if he or she inadvertently pressed the button or the emergency alarm was triggered for some other reasons, to terminate the alarm even before it is sent out. This period routinely lasts between 5 and 10 seconds, on the one hand enough time to prevent the alarm from being triggered, and on the other hand not a significant length of time that might result in a substantial deterioration in the situation of the triggering party.

This time span can now be used by the triggering user to independently evaluate his or her emergency. This process and the result of this process will be referred to as “differentiation” below.

If the user selects nothing, or cannot select anything, no separate notification—and thus the standard case—would be transmitted; as a consequence, for example, all filed first responders are informed about the emergency.

If a sensor, e.g., a fall sensor, triggers the alarm, a differentiation can automatically be made as to what type of emergency led to the alarm being triggered; given an armband or necklace with fall sensor and manual actuating button, for example, a notification could be made about the fall itself or about the manual actuation of the emergency button as the differentiation. A recipient can now use this to determine whether the triggering person fell or was himself or herself able to turn off the emergency signal, potentially along with data underlying the triggering event.

In particular given a manual actuation, the user of the emergency system is now further given the opportunity to select situations that were predefined on a list and/or preset by the user himself or herself. Typical situations would include falls, fire, nausea, dizziness and the like.

In a modification of the invention, the user can additionally or only file special differentiations, which might only play a role individually and/or regionally and/or chronologically, for example in a civil war region where grenades are hitting or attackers are sighted, or loss of orientation during an excursion.

### Consequences of Differentiation

a) Notification of Differentiated Groups of People

As a consequence of the setting—differentiation—selected by the user, it can be filed a priori that various people or groups are informed.

For example, when selecting the differentiation “hunger” in the aforementioned case, only the message “I am hungry” would be sent to the family member preset for this differentiation, while a broader preset group of people could be informed given the differentiation “I fell down”, and relatives and the family doctor could be informed if “nausea” were the default.

As a rule, the default can be filed or provided with 2 components: First a specific urgency, i.e., how fast should the recipient act, and second, the intensity which the actual or perceived severity of the emergency has in the eyes of the user.

Let the two extremes of fire and hunger be cited as an example: In the case of fire, both intensity and urgency are extremely high, so that the routinely preset people and preset firefighter number are contacted, meaning a large group of people, and immediate and targeted assistance is requested; the default of hunger would routinely reflect a low intensity and even lower urgency, since reacting within 20-30 minutes is usually more than sufficient, and no pain associated with hunger can be discerned, at least within a normal framework, but rather just an initially unpleasant sensation.

This can have ramifications for the graphic representation of the messaging function: The user can be given the opportunity to still change both the intensity and urgency. For example, in the event of hunger, if the user has given himself or herself more time to trigger the alarm, so that he or she can set the urgency to “I really want to eat something in the next few minutes” and intensity to “I am so hungry that it hurts/I feel sick”.

b) Combination of Life Circles and Differentiation

In conjunction with a patent of the patent applicant (WIPO WO 2014/170081, DE 812752671), it can be determined through the preset urgency and also through modifications of both urgency and intensity that other groups of people or less broad groups of people and first responders are contacted.

For example, the setting “strange people in the house” can as a rule be sent to neighbors of the house at a low urgency and low intensity; however, if the intensity and/or urgency were to be increased, this could be preformulated for a larger group of people with the aim, for example, of also calling the police, e.g., if the user is able to perceive an attempted break-in by strange people at the exit.

c) Technical Consequences

Differentiation can also entail various technical consequences, i.e., influence ensuing system processes. In an exemplary application for a device intended in particular to help young women avoid rape, the preset transmission of emergency situations ranging from
simple—“I am in a strange location”,
serious—“Strange people are approaching me”, all the way to
acute—“A rape has started”
   in addition to the pure information can result in various technical consequences; in a simple and serious, but not acute case, only a positional indication will be transmitted with a request that the recipient inquire within minutes about the condition of the female user; in the serious case, the positional transmission could also be accompanied by establishing a telephone connection with the same or other or more people, for example, so as to have witnesses to the situation; and in the acute attempted rape not even inform a third person, but rather only or additionally the local police.

In addition, at least one additional technical consequence can be preset, such as:
Connecting a telephone or video conference with the first responders and local officials, i.e., the police, firefighters and medical services, so that the latter can trace the events and correspondingly take better action,
Triggering technical events, like turning on medical equipment that corresponds to the notified event, or triggering technical equipment, for example to spray color vapor or powder to better localize the user, and finally
Triggering automated warning messages that contain the environment and differentiation of the incident, e.g., the automated search and display of close-by defibrillators given a “heart attack” differentiation, so that arriving first responders already know acoustically where the next defibrillator is located.
Sending other preset information to people to be notified, whether via the device used for triggering or external equipment that stores the information to be transmitted (“servers”), regardless of whether these are static or were discovered by an algorithm that uses the determined values and/or selected differentiations.

2. Alarm and Simultaneous Differentiation

In a modification of the invention, it is possible for alarm triggering and differentiation to be synchronized.

In this case, the alarm button and predefined emergency states are chronologically next to each other. Therefore, when a specific emergency state is pressed, this simultaneously triggers the alarm, possibly once again with the aforementioned countdown as a safeguard against erroneous triggering.

This can take the form of either only showing the alarm button, which is then pushed toward the state to be transmitted, or showing no alarm button, but rather all or part of the predetermined emergency states on the display, which when manually pressed then simultaneously trigger the emergency alarm and countdown.

3. Information without Differentiation

In another modification to 1 and 2 of the invention, an area, preferably on the left and/or lower edge of the depiction, can be reserved for displaying information without intensity and/or urgency, e.g., with the content “please call back at your convenience”. This differs from a normal message in that it can be sent to one, several or all preset “first responders”.

4. Change During User Movement

Apart from the resultant clearer graphic representation, one modification makes it possible to change the type of differentiation, depending on where the user is located and/or whether he or she
is moving or acting statically, and likewise
is at home or in another house, outside or in a defined life circle (see Patent WIPO WO 2014/170081-DE 812752671). The Wi-Fi blink technology described in the aforementioned patent can be used for this purpose.

This makes it possible to discern whether
the user is at home, and thus only subject to typical health hazards,
has made his or her way to the workplace, for which special dangers associated with the work have already been defined, and/or
is moving at a speed of
   between 1 and 6-7 km/h (typical walking),
   between 7 and 12-16 km/h (jogging/running up to an endurance race pace, depending on user constitution),
   or between about 13 and 110 to 150 km/h (typical driving speed in a passenger car),
   or even faster (typically the speed of a possibly public transport, such as trains and airplanes).

Specific danger situations and/or first responders can be predefined [for] each of these locations and speeds of movement, and differentiated accordingly as the location or speed of movement arises.

1. A method for differentiating constitutional states when triggering an emergency alarm on a portable electronic device, comprising:
Displaying a plurality of alarm states;
Determining a first user selection, wherein the first selection determines a type of alarm state;
Displaying an urgency and/or intensity scale;
Determining a second user selection, wherein the second selection corresponds to an urgency and/or intensity of the alarm state of the first selection; and
Transmitting an alarm signal including previously acquired location data for the electronic device to a predetermined group of alarm recipients, wherein the predetermined group of alarm recipients is determined in advance by the user in the portable electronic device as a function of the number of alarm states and the urgency and/or intensity of an alarm state, wherein given predefined locations, other correspondingly defined alarm states are displayed, and corresponding other groups of alarm recipients are informed with an adjusted alarm signal.

2. The method according to claim 1, wherein the detection result of a sensor of the electronic device limits the display of a plurality of alarm states.

3. The method according to claim 1, wherein each possible alarm state corresponds to an adjustable group of alarm recipients, and wherein the second user selection expands the adjustable group of alarm recipients as a function of the selected urgency and/or intensity if the urgency and/or intensity exceeds a predetermined threshold of the alarm state.

4. The method according to claim 1, wherein the method is implemented on an electronic device, which is integrated into a personal emergency system, PERS, or a social emergency network, SEN.

5. The method according to claim 1, further comprising:
Displaying a scale corresponding to a privacy setting;
Determining a privacy user selection; and
Limiting the group of alarm recipients determined through the first and second user selection based on the privacy selected by the user.

6. An electronic device for differentiating constitutional states when triggering an alarm, comprising:
A display device; and
A calculation unit, adjusted to:
Display a plurality of alarm states on the display device;
Determine a first user selection, wherein the first selection determines a type of alarm state;
Display an urgency and/or intensity scale on the display device;
Determine a second user selection, wherein the second selection corresponds to an urgency and/or intensity of the alarm state of the first selection; and
Transmit an alarm signal including previously acquired location data for the electronic device to a predetermined group of alarm recipients, wherein the predetermined group of alarm recipients is determined in advance by the user in the portable electronic device as a function of the number of alarm states and the urgency and/or intensity of an alarm state, wherein given predefined locations, other correspondingly defined alarm states are displayed, and corresponding other groups of alarm recipients are informed with an adjusted alarm signal.

7. The electronic device according to claim 6, further comprising:
a sensor, wherein a detection result of the sensor limits the display of the plurality of alarm states.

8. The electronic device according to claim 6, wherein each possible alarm state corresponds to an adjustable group of alarm recipients, and wherein the first user selection expands the adjustable group of alarm recipients as a function of the selected urgency and/or intensity if the urgency and/or intensity exceeds a predetermined threshold of the alarm state.

9. The electronic device according to claim 6, wherein the electronic device is integrated into a personal emergency system, PERS, or a social emergency network, SEN.

10. The electronic device according to claim 6, wherein the calculation unit is further adjusted to:
Display a scale corresponding to a privacy setting on the display device;
Determine a privacy selection of the user; and
Limit the group of alarm recipients determined by the first and second user selection based on the privacy selected by the user.

11. A system for differentiating according to claim 1, comprised of a display of preset constitutional states that can be selected after triggering an emergency alarm; wherein the system is adjusted to inform preset first responders determined based on a selection.

12. The system according to claim 11, in which the user selection can trigger other, preset external technical consequences.

13. The system according to claim 11, in which the selection of the constitutional state is synchronized with the triggering of the emergency signal.

14. The system according to claim 11, in which other correspondingly predefined constitutional states are displayed and fixed at determined speeds, and based on the selection made relayed to other groups of people with an adjusted notification.

15. (canceled)

16. A computer program product, which is adjusted so as to implement a method according to claim 1 when executed by an electronic device.

17. A computer-readable storage medium comprised of a program code that implements a method according to claim 1 when executed by an electronic device.
